(19) United States
(12) Patent Application Publication
(10) Pub. No.: US 2025/0292543 A1
(43) Pub. Date: Sep. 18, 2025

(54) IMAGE RECOGNITION DEVICE, STORAGE MEDIUM, AND IMAGE RECOGNITION METHOD

(71) Applicants: DENSO CORPORATION, Kariya-city (JP); TOYOTA JIDOSHA KABUSHIKI KAISHA, Toyota-shi (JP)

(72) Inventor: Takuya UMEMURA, Kariya-city (JP)

(21) Appl. No.: 19/075,399

(22) Filed: Mar. 10, 2025

(30) Foreign Application Priority Data
Mar. 12, 2024 (JP) 2024-038295

(51) Int. Cl. G06V 10/764; G06V 10/12; G06V 10/25; G06V 20/58

(52) U.S. Cl. CPC G06V 10/764; G06V 10/12; G06V 10/25; G06V 20/58; G06V 2201/08

(57) ABSTRACT

An image recognition device acquires camera images captured by at least one camera, detects recognition targets in the camera images and estimates a class of the detected recognition targets respectively, and determines whether a plurality of recognition targets that are estimated to be of different classes are the same recognition targets.

### CROSS-REFERENCE TO RELATED APPLICATIONS

The present application claims priority to Japanese Application No. 2024-38295, filed on Mar. 12, 2024. The contents of these applications are incorporated herein by reference in their entirety.

### BACKGROUND

### 1. Technical Field

This disclosure relates to an image recognition device, a storage medium, and an image recognition method.

### 2. Related Art

Conventionally, there are image recognition devices that detect recognition targets such as people and vehicles in camera images. Some image recognition devices have various innovations to improve the detection rate of the recognition targets. For example, JP2013210705A1 discloses an image recognition device that assumes that the position of a recognition target recognized in a current frame is the same recognition target when it is within a predetermined distance from a position of the recognition target recognized in a past frame.

### SUMMARY

A first means is an image recognition device including: an acquisition unit that acquires camera images captured by at least one camera, an estimation unit that detects recognition targets in the camera images and estimates a class of the respective detected recognition targets respectively, and a determination unit that determines whether a plurality of recognition targets that are estimated to be of different classes are the same recognition targets.

A second means is a non-transitory computer-readable storage medium storing an image recognition program, the recognition program causing the computer to: acquire camera images captured by at least one camera, detect recognition targets in the camera images and estimates a class of the detected recognition targets respectively, and determine whether a plurality of recognition targets that are estimated to be of different classes are the same recognition targets.

A third means is an image recognition method performed by an image recognition device, the image recognition method including: acquiring camera images captured by at least one camera, detecting recognition targets in the camera images and estimates a class of the detected recognition targets respectively, and determining whether a plurality of recognition targets that are estimated to be of different classes are the same recognition targets.

### BRIEF DESCRIPTION OF THE DRAWING

FIG. 1 is a block diagram of the driving assistance system.

FIG. 2 is a block diagram showing the functions of the first form of image recognition device.

FIG. 3 shows an example of a camera image in the first form.

FIG. 4 illustrates the range of the first predetermined distance.

FIG. 5 illustrates how the classes are determined.

FIG. 6 is a flowchart showing the process performed by the image recognition device in the first form.

FIG. 7 is a block diagram of the second embodiment of the driving assistance system.

FIG. 8 is a block diagram showing the functions of the image recognition device of the second form.

FIG. 9 shows an example of a camera image in the second form.

FIG. 10 is a flowchart showing the process performed by the image recognition process in the second form.

FIG. 11 is a flowchart showing the process performed by the image recognition process in the third form.

FIG. 12 illustrates the range of the first predetermined distance in a variant example.

### DETAILED DESCRIPTION OF THE PREFERRED EMBODIMENTS

In recent years, there are technologies that use machine learning, such as deep learning, to generate inference models, detect recognition targets in camera images by the inference models, and estimate the class of the recognition targets.

However, some recognition targets of image recognition systems, such as motorcycles, tend to have their class incorrectly estimated depending on direction of image capture and distance to the target. When the class differs, even the same recognition targets can be mistakenly judged to be different objects.

The present invention was made in view of the above problems, and a principal object of the present invention is to provide an image recognition device, a storage medium, and an image recognition method that can appropriately determine whether a plurality of recognition targets are the same recognition targets.

A first means to solve the above problem is an image recognition device including: an acquisition unit that acquires camera images captured by at least one camera, an estimation unit that detects recognition targets in the camera images and estimates a class of the detected recognition targets respectively, a determination unit that determines whether a plurality of recognition targets that are estimated to be of different classes are the same recognition targets.

As described above, since the device includes the determination unit, even when the class is estimated to be different, the recognition targets of different classes may be determined to be the same recognition targets. Therefore, the image recognition device can determine whether the recognition targets of different classes are the same recognition targets.

A second means to solve the above problem is a non-transitory computer-readable storage medium storing an image recognition program, the recognition program causing the computer to: acquire camera images captured by at least one camera, detect recognition targets in the camera images and estimates a class of the detected recognition targets respectively, and determine whether a plurality of recognition targets that are estimated to be of different classes are the same recognition targets.

As described above, since the image recognition program stored by the non-transitory computer-readable storage medium causes the computer to determine whether a plurality of recognition targets that are estimated to be of different classes are the same recognition targets, the recognition targets of different classes may be determined to be the same recognition targets. Therefore, the computer can determine whether the recognition targets of different classes are the same recognition targets.

A third means to solve the above problem is an image recognition method performed by an image recognition device, the image recognition method including: acquiring camera images captured by at least one camera, detecting recognition targets in the camera images and estimates a class of the detected recognition targets respectively, and determining whether a plurality of recognition targets that are estimated to be of different classes are the same recognition targets.

As described above, since the image recognition method includes determining whether a plurality of recognition targets that are estimated to be of different classes are the same recognition targets, the recognition targets of different classes may be determined to be the same recognition targets. Therefore, the image recognition device can determine whether the recognition targets of different classes are the same recognition targets.

The following is a detailed description of embodiments of the image recognition device, the storage medium, and the image recognition method in the present disclosure, with reference to the drawings. In principle, identical or equivalent portions in the figures are marked with the same symbols and their descriptions are not repeated among the embodiments and variations.

### First Embodiment

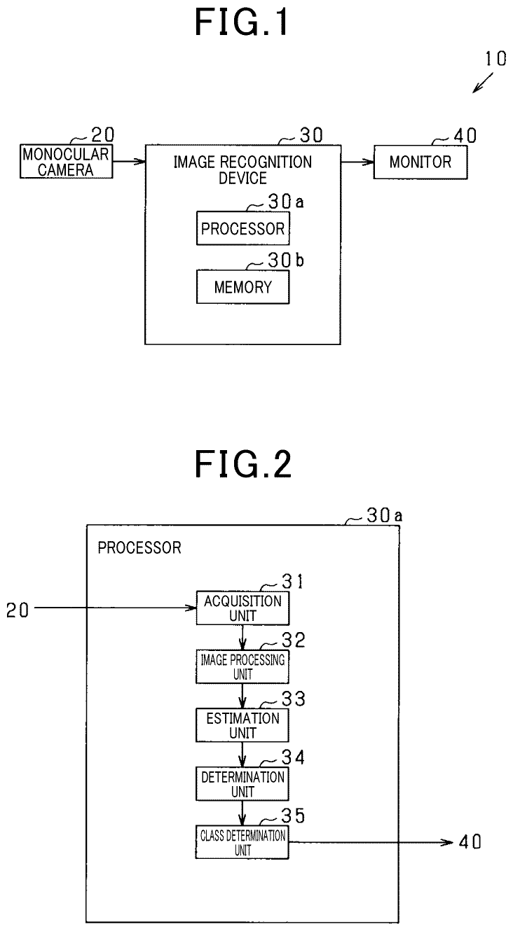

FIG. 1 shows a driving assistance system 10 to which the image recognition device in the first embodiment is applied. The driving assistance system 10 is installed in a vehicle and performs driving assistance control such as automatic driving.

As shown in FIG. 1, the driving assistance system 10 has a monocular camera 20, that is an example of a camera, an image recognition device 30, and a monitor 40. The image recognition device 30 communicates with the monocular camera 20 and monitor 40 by wired or wireless means respectively.

The monocular camera 20 is a camera with an image sensor such as a CCD or CMOS. The monocular camera 20 is positioned near the top of the windshield of the vehicle, for example, and captures images of scenery including a road surface in front of the vehicle. The monocular camera 20 captures moving images at a predetermined frame rate. The camera image captured by the monocular camera 20 is output to the image recognition system 30. The driving assistance system may have a stereo camera instead of the monocular camera 20.

The image recognition device 30 is mainly composed of a microcomputer equipped with a processor 30a, such as a CPU, and a memory 30b. The memory 30b is a non-transitory tangible storage medium. The functions of the microcomputer are realized by software stored in the memory 30b and the processor 30a, software only, hardware only, or a combination thereof. For example, if the microcomputer includes electronic circuits that are hardware, the microcomputer includes digital or analog circuits that include logic circuits. The processor 30a of the microcomputer executes a program stored in the memory 30b. The program realizes, for example, the functions shown in FIG. 2, etc. When the program is executed, the method corresponding to the program is performed. The memory 30b may be, for example, a nonvolatile memory. The program stored in the memory 30b can be downloaded and updated via a communication network such as the Internet using a method called OTA (Over the Air).

The image recognition device 30 may, for example, have functions as an acquisition unit 31, an image processing unit 32, and an estimation unit 33, as shown in FIG. 2.

The acquisition unit 31 sequentially acquires camera images captured by the monocular camera 20. The camera images may be replaced by image information equivalent to the camera images. The same applies hereinafter.

The image processing unit 32 converts the camera images acquired by the acquisition unit 31 into overhead images (bird's-eye view images). The conversion method may be any well-known method. For example, the conversion method may be to perform a perspective transformation to generate bird's-eye view images of the image range of the monocular camera 20 looking down vertically from an elevated position. Image processing section 32 may convert the camera images (two-dimensional image) into three-dimensional images. In this way, the image processing section 32 clarifies the features of the camera images and/or positional relationships of the object in the camera images as a pre-processing step for an image recognition.

The estimation unit 33 detects recognition targets in the camera images acquired by the acquisition unit 31. The estimation unit 33 estimates classes of the detected recognition targets respectively. The method of detecting recognition targets from the camera images and the method of estimating the classes of the detected recognition targets may be any well-known method. For example, one or both of them may be template matching, a method using a convolutional neural network (CNN), or semantic segmentation. The estimation unit 33 of the first embodiment uses an inference model generated by deep learning to detect the recognition targets in the camera images and to estimate the classes of the detected recognition targets respectively.

In this embodiment, detection and class estimation are performed based on the camera images. However, detection and class estimation may also be performed in the images that have been preprocessed by the image processing unit 32, for example, the overhead images converted from the camera images, the three-dimensional images, or image data.

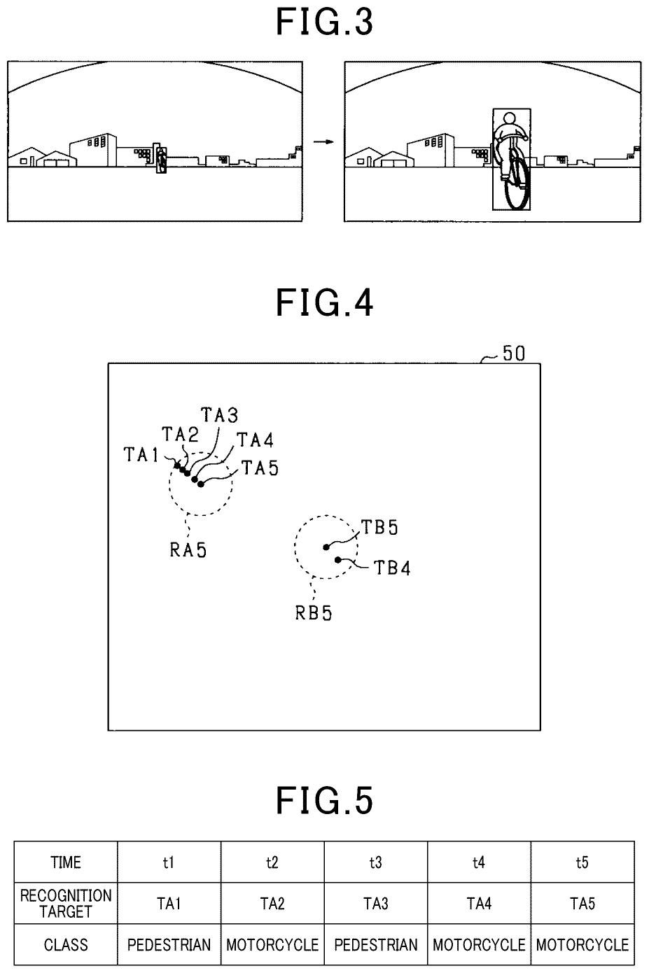

The estimation unit 33 may incorrectly estimate the classes of the recognition targets. For example, a motorcycle may be misrecognized as a pedestrian because their characteristics are similar to those of pedestrian, depending on an imaging angle and distance from the camera. Therefore, their classes may be misrecognized as pedestrian. The example shown in FIG. 3 is illustrated. The left part of FIG. 3 shows an image of a motorcycle in some distance, and the right part shows an image of a motorcycle approaching the vehicle. In the image in the left part of FIG. 3, it is difficult to recognize the features of the motorcycle, and it may be misrecognized as a pedestrian. When same recognition targets are judged to be a different recognition target due to different classes, various problems may occur, such as the following.

For example, when the monitor displays an identification graphic indicating the class of the estimated recognition target (such as a bicycle or a pedestrian marker), problems arise when a motorcycle or pedestrian suddenly disappears from the monitor, or when a motorcycle and a pedestrian suddenly switch places. In addition, when speed is obtained by tracking the recognition target in a time series, it is impossible to accurately measure the speed. The image recognition device 30 of the first embodiment has a function as a determination unit 34 and a function as a class determination unit 35. These functions are described below.

The determination unit 34 determines whether a plurality of recognition targets whose classes estimated by the estimation unit 33 are different from each other are the same recognition targets (same object). The plurality of recognition targets are those detected in different frame images (or processed frame images, etc.), and the same object may be reflected in different frames in chronological order. The determination unit 34 determines that the plurality of recognition targets are the same recognition targets when the estimation unit 33 detects the plurality of recognition targets of different classes in the plurality of camera images captured by the monocular camera 20 between the first and second times, for example, and the plurality of recognition targets are located within a first predetermined region. The first predetermined region is a region in which a distance from a reference point is less than or equal to a first predetermined distance.

The predetermined period from the first time to the second time can be any period but should be a short period of time. For example, the predetermined period can be in the range of 0.5 to 3 seconds, or a period during which 10 to 100 frames of camera images can be acquired. The predetermined period may be changed according to the speed of the vehicle in which the driving assistance system 10 is installed, or it may be changed by the frame rate of the monocular camera 20.

“The plurality of recognition targets are located within a first predetermined region” means, for example, that the second recognition target recognized in the camera image acquired before the second time is located within the first predetermined distance as a radius centered at the position of the first recognition target detected in the camera image acquired at the second time (an example of “reference point”), when viewed from overhead. The second time is the last time in the time series.

For example, assume that a recognition target TA1 was detected in the camera image at time t1, a recognition target TA2 was detected in the camera image at time t2, a recognition target TA3 was detected in the camera image at time t3, a recognition target TA4 and a recognition target TB4 were detected in the camera image at time t4, and a recognition targets TA5 and a recognition target TB5 were detected in the camera image at time t5. FIG. 4 shows the positions of the recognition target TA1, the recognition target TA2, the recognition target TA3, the recognition target TA4, the recognition target TB4, the recognition target TA5 and the recognition target TB5 detected in the overhead image 50. The positions of the recognition targets are indicated by black dots, and the range of the first predetermined distance is indicated by a circle. The time series is from point t1 to point t2 to point t3 to point t4 to point t5, and the time interval between the points is constant.

In this case, the determination unit 34 determines that the recognition targets TA1 to TA4 existing inside the range of the first predetermined distance RA5 centered on the location of the last detected recognition target TA5 are the same recognition targets as recognition target TA5, even if they are of a different class from TA5. Similarly, the determination unit 34 determines that the recognition target TB4 that exists inside the first predetermined distance range RB5 centered on the last detected recognition target TB5 is the same recognition target as the recognition target TB5 even if it is of a different class from the recognition target TB5. On the other hand, since recognition target TB4 and recognition target TB5 do not exist inside the range of the first predetermined distance RA5 centered on the location of the last detected recognition target TA5, the determination unit 34 determines that recognition target TB4 and recognition target TB5 are not the same recognition target as recognition target TA5 even if they are of the same class as recognition target TA5. Similarly, the determination unit 34 determines that recognition targets TA1 to TA5 are not the same as recognition target TB5 even if they are of the same class as recognition target TB5, because recognition targets TA1 to TA5 do not exist within the first predetermined distance range RB5 centered on the location of the last detected recognition target TB5.

The determination unit 34 identifies the plurality of recognition targets located within the first region as a group of recognition targets that are considered to be the same recognition targets, and when there are plurality of groups of recognition targets, the determination unit 34 identifies each group of recognition targets. In the example shown in FIG. 4, the determination unit 34 identifies a group of plurality of recognition targets TA1 to TA5 that exist within the first predetermined distance range RA5 and a group of plurality of recognition targets TB4 to TB5 that exist within the first predetermined distance range RB5 as a group of recognition objects, respectively.

The class determination unit 35 unifies the class of each of the plurality of recognition targets identified as the same group by the determination unit 34 according to majority rule.

A specific example will be given below. As shown in FIG. 5, the recognition target TA1, whose class is estimated to be “pedestrian,” is detected in the camera image at time t1, the recognition target TA2, whose class is estimated to be “motorcycle” is detected in the camera image at time t2, the recognition target TA3, whose class is estimated to be “pedestrian” is detected in the camera image at time t3, the recognition target TA4, whose class is estimated to be “motorcycle” is detected in the camera image at time t4, and the recognition target TA5, whose class is estimated to be “motorcycle” is detected in the camera image at time t5. The time series is from point t1 to point t2 to point t3 to point t4 to point t5, and the time interval between the points is constant.

When the determination unit 34 determines that the recognition targets TA1 to TA5 are the same recognition target (when identified as the same group), the class determination unit 35 determines that the class of each of recognition targets TA1 to TA5 is “motorcycle” in accordance with the majority rule.

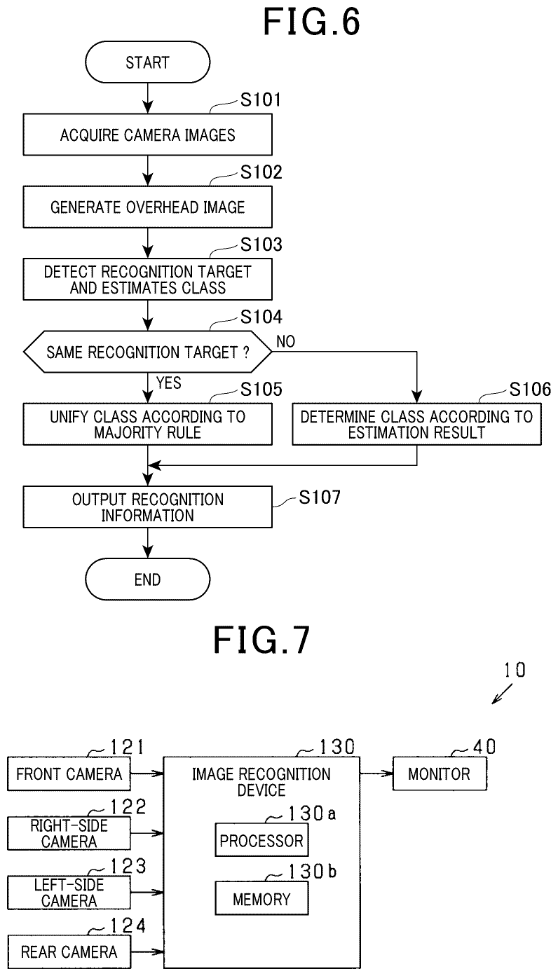

Next, the flow of the image recognition process related to detection and class estimation of the recognition targets in the first embodiment will be described with reference to FIG. 6. The image recognition process is performed by the image recognition system 30 at each predetermined cycle.

First, the acquisition unit 31 of the image recognition device 30 acquires camera images captured by the monocular camera 20 from the monocular camera 20 in sequence (step S101).

Next, the image processing unit 32 of the image recognition device 30 performs pre-processing on the camera image acquired by the acquisition unit 31 (step S102). In step S102, for example, the overhead image is generated.

Next, the image processing unit 33 of the image recognition device 30 detects the recognition target in the camera images (or the preprocessed camera images) and estimates the classes of the detected recognition targets (step S103).

Next, the determination unit 34 of the image recognition device 30 determines whether the recognition targets whose classes are estimated to be different by the estimation unit 33 are the same recognition targets (step S104). The determination method is as described above. The determination unit 34 determines that the plurality of recognition targets whose classes are estimated to be the same and whose distance exceeds the first predetermined distance are not the same recognition targets.

When the determination result of step S104 is affirmative, that is, when it is determined that the recognition targets are the same recognition targets although the classes are estimated to be different, the class determination unit 35 of the image recognition device 30 unifies the classes of the plurality of recognition targets that are estimated to be the same recognition targets according to majority rule (Step S105). When there are plurality of groups of the recognition targets that are presumed to be the same recognition targets, as shown in FIG. 4, the class determination unit 35 unifies the class of each recognition targets belonging to each of the groups. In the example shown in FIG. 4, the classes of each of the recognition targets included in the group of recognition targets TA1 to TA5 and the class of each of the recognition targets included in the group of recognition targets TB4 to TB5 are determined respectively.

On the other hand, when the determination result of step S104 is negative, that is, when the recognition targets are determined to be different, the class determination unit 35 determines the class estimated by the estimation unit 33 as the class of the respective recognition target (step S106).

The image recognition device 30 outputs the position of the detected recognition target and the recognition information on the respective recognition target class determined in step S105 or step S106 to the outside of the image recognition device 30 (step S107). Then the image recognition device 30 ends the image recognition process.

When receiving this recognition information, the monitor 40 displays the location and class of each of the recognition targets.

According to the above embodiment, the following effects can be achieved.

The determination unit 34 determines whether the recognition targets whose classes are estimated to be different by the estimation unit 33 are the same recognition targets. This enables appropriate determination of whether the recognition targets are the same recognition targets, since even when the classes are estimated to be different, it is not automatically determined that the recognition targets are different objects detected.

Even if the plurality of the recognition targets of different classes are detected from plurality of camera images captured within a predetermined time, when the distance between those recognition targets is very close, they are likely to be determined to be the same recognition targets and the class estimation is likely to be wrong. Therefore, the determination unit 34 determines that the plurality of recognition targets that are estimated to be of different classes are the same recognition target when they are within the first predetermined distance range.

More precisely, when a plurality of recognition targets of different classes are detected in the plurality of camera images captured by the monocular camera 20 between the first time and the second time, and the plurality of recognition targets are located within the first predetermined region, the determination unit 34 determines that the plurality of recognition targets located within the first predetermined region are the same recognition targets. This allows the determination unit 34 to appropriately determine whether the recognition targets are the same recognition targets even when the classes are estimated to be different.

In this embodiment, when the recognition targets detected from the first time to just before the second time exist within the first predetermined distance range centered on the location of the recognition target detected at the second time, the determination unit 34 determines that they are the same recognition target even if their classes are different.

The reasonable distance range within which plurality of recognition targets are determined to be the same recognition targets differs depending on the class of the recognition targets. For example, the reasonable distance range differs between pedestrian and vehicles because they move at different speeds. Therefore, the determination unit 34 performs determination using the first predetermined distance that differs depending on the class. This enables more accurate determination of whether they are the same recognition targets compared to the case where the first predetermined distance is a fixed value.

When the plurality of recognition targets are determined to be the same recognition targets, the class determination unit 35 unifies the class of each of the plurality of recognition targets determined to be the same recognition target based on detection information from the plurality of camera images acquired in time series. Specifically, the class determination unit 35 unifies the class of each of the plurality of recognition targets determined to be the same recognition target by the determination unit 34 according to majority rule. This makes it possible to correctly re-determine the class of the recognition target.

### Second Embodiment

A second embodiment is described in which some of the configurations of the first embodiment are changed. The same configuration as in the first embodiment will be omitted with the same symbol.

As shown in FIG. 7, in the second embodiment, the vehicle has plurality of (four) cameras 121 through 124. Specifically, the imaging range of the front camera 121 is in front of the vehicle, the range of the right-side camera 122 is on the right side of the vehicle, the range of the left-side camera 123 is on the left side of the vehicle, and the range of the rear camera 124 is behind the vehicle. Each of the front camera 121 and the rear camera 124 has an angle of view of approximately 130 degrees horizontally with the center (optical axis) in the front-rear direction of the vehicle. Each of the right-side camera 122 and the left-side camera 123 has an angle of view of approximately 130 degrees horizontally centered (optical axis) in the direction orthogonal to the front-rear direction of the vehicle. The number of cameras, imaging range, imaging direction (direction of optical axis), and angle of view may be changed as desired. However, in the second embodiment, the image capturing ranges of the front camera 121 and the right side camera 122, and the image capturing ranges of the front camera 121 and the left side camera 123, respectively, partially overlap each other, and the image capturing ranges of the rear camera 124 and the right side camera 122, and the image capturing ranges of the rear camera 124 and the left side camera 123, respectively, partially overlap each other. Each camera may capture either static images or moving images.

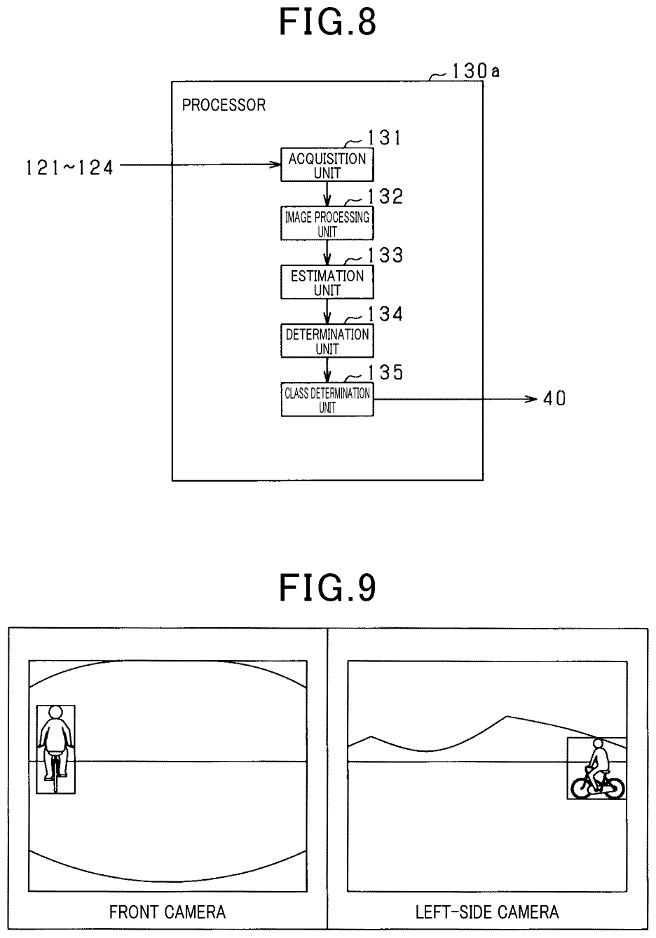

The image recognition device 130 of the second embodiment, like the first embodiment, is equipped with the processor 130a and the memory 130b. The processor 130a executes a program stored in the memory 130b to realize the various functions shown in FIG. 8.

As shown in FIG. 8, the image recognition device 130 of the second embodiment has functions as an acquisition unit 131, an image processing unit 132, an estimation unit 133, a determination unit 134, and a class determination unit 135.

The acquisition unit 131 acquires camera images (or image information equivalent to each camera image, the same hereinafter) captured by each of the cameras 121 through 124.

Image processing unit 132 converts each of the camera images of each camera 121 to camera 124 acquired by acquisition unit 131 into an overhead image (bird's-eye view image). The conversion method is the same as in the first embodiment.

The estimation unit 133 detects recognition targets for each camera image acquired by the acquisition unit 131 and estimates the classes of the detected recognition targets respectively. The object detection method and the object recognition method may be the same as in the first embodiment. When estimating the classes of the recognition targets, the estimation unit 133 of the second embodiment calculates confidence level of the estimated classes respectively. The confidence level is calculated with a tendency to increase as the amount of features of the recognition target increases.

In the second embodiment, since the camera's imaging range partially overlaps and the estimation unit 133 estimates the class of the recognition target for each camera image, the recognition target may be the same recognition target. Even for the same recognition target, the estimation unit 133 may mistakenly select a different class because there are imaging directions in which the features of the recognition target are likely to appear and those in which they are unlikely to appear. FIG. 9 explains this in detail. The left part of FIG. 9 is a camera image of the front camera 121 and the right part is a camera image of the left-side camera 123. As shown in FIG. 9, the amount of features of motorcycles increase or decrease depending on the image capture direction. In FIG. 9, the camera image of the left-side camera 123 has more features of two wheeled vehicles than the camera image of the front camera 121. In this case, even for the same recognition target, the estimation unit 133 may estimate the class of the recognition target as “pedestrian” based on the camera image of the front camera 121 and the class of the recognition target as “motorcycle” based on the camera image of the left side camera 123. Various problems may arise when the same recognition target is determined to be a different recognition target due to different classes.

For example, in the case of displaying identification figures indicating classes (e.g., bicycle and pedestrian marks) on the monitor 40, a motorcycle and a pedestrian may be simultaneously (doubly) displayed at the same point, even if they are the same recognition target, causing confusion. Therefore, in the second embodiment, the determination unit 134 and the class determination unit 135 are configured as follows.

When the plurality of recognition targets of different classes are detected from the plurality of camera images captured by the plurality of cameras 121 to 124 with different image capture ranges at the same time, and when the plurality of recognition targets exist at the same position, the determination unit 134 determines that the plurality of recognition targets are the same recognition target. The same position means the position in real space, not the position in the camera image space.

The determination unit 134, for example, determines whether the plurality of recognition targets exist at the same position based on the overhead image generated by the image processing unit 132. The term “same position” actually means the same position after taking into account various errors such as detection errors during recognition, mounting errors of the cameras 121 to 124, and errors based on distortion caused by camera lenses. In other words, in practice, when the plurality of recognition targets of different classes exist within the range of the second predetermined distance taking these errors into account, the determination unit 134 determines them to be the same recognition targets.

The class determination unit 135 unifies the class of the plurality of recognition targets of different classes respectively, based on the confidence level in the case where the plurality of recognition targets of different classes are determined to be the same recognition targets by the determination unit 134. For example, when the confidence level of the class “pedestrian” of the recognition target detected based on the camera image of the front camera 121 is 60%, while the confidence level of the class “motorcycle” of the recognition target detected based on the camera image of the left side camera 123 is 90%, the class determination unit 135 unifies the class to be “motorcycle” with the higher confidence level.

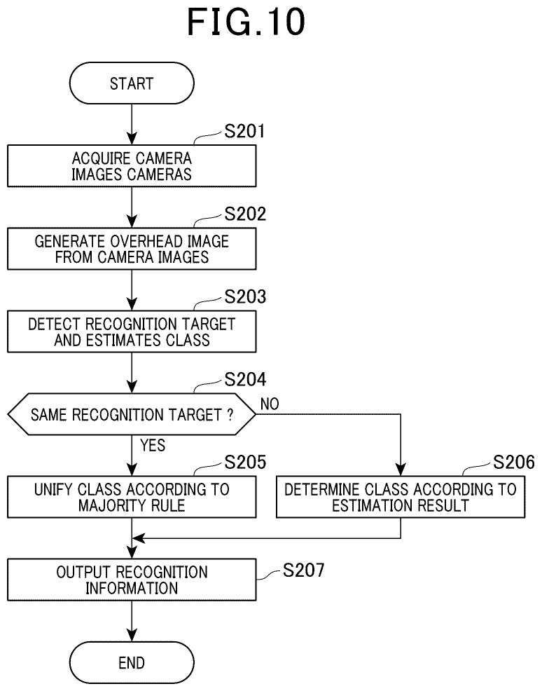

Next, the flow of the image recognition process in the second embodiment will be described with reference to FIG. 10. The image recognition process is performed by the image recognition system 130 at each predetermined cycle.

First, the acquisition unit 131 of the image recognition device 130 acquires a plurality of camera images captured by the plurality of cameras (step S201).

Next, the image processing unit 132 of the image recognition device 130 performs preprocessing on the plurality of camera images acquired by the acquisition unit 131 to generate the overhead image based on the plurality of camera images (step S202).

Next, the estimation unit 133 of the image recognition device 130 detects the recognition targets for the plurality of camera images and estimates the class of each detected recognition target, respectively (step S203). Also, the estimation unit 133 calculates the confidence levels for the class estimation results respectively.

Next, the determination unit 134 of the image recognition device 130 determines whether the recognition targets estimated to be of different classes by the estimation unit 133 are the same recognition target (step S204). In step S204, when the plurality of recognition targets of different classes are detected in the plurality of camera images captured by plurality of cameras with different ranges at the same time and the plurality of recognition targets exist at the same location, the determination unit 134 determines that the plurality of recognition targets are the same recognition targets.

When the result of this determination is affirmative, that is, if it is determined that the recognition targets are the same recognition targets although the classes are estimated to be different, the class determination unit 135 of the image recognition device 130 unifies the class of the plurality of recognition targets with different classes based on the confidence level corresponding to each of the plurality of recognition targets (Step S205). As in the first embodiment, when there is a plurality of groups of recognition targets that are considered to be the same recognition target, the class determination unit 135 unifies the class of the recognition targets belonging to the group for respective group.

On the other hand, when the determination result of step S204 is negative, the class determination unit 135 determines the class estimated by the estimation unit 133 as the class of each recognition target (step S206).

The image recognition device 130 outputs the position of the detected recognition targets and the recognition information about the class of each of the recognition targets determined in step S205 or step S206 to the outside (step S207). Then the image recognition device 30 ends the image recognition process. When receiving this recognition information, the monitor 40 displays the location and class of each of the recognition targets.

According to the above embodiment, the following effects can be achieved.

When the image capture ranges and image capture angles are different, the estimation unit 133 may make a mistake in class estimation because the shape, etc. of the target differs and the feature values are different even if they are the same recognition targets. For this reason, even when plurality of recognition targets of different classes are detected from the plurality of camera images captured by the plurality of cameras 121-124 with different image capture ranges at the same time, when these recognition targets exist at the same position, the determination unit 134 determines that they are the same recognition targets. This allows appropriate determination of whether the recognition targets are the same recognition targets, even when the classes are estimated to be different.

When it is determined that the plurality of recognition targets with different classes are the same recognition targets, the class determination unit 135 determines the class of the recognition target based on the detection information from the plurality of camera images captured by the plurality of cameras 121 to 124. In other words, if it is determined that the recognition targets are the same recognition targets although the classes are estimated to be different, the class determination unit 135 of the image recognition device 130 unifies the class of the plurality of recognition targets with different classes based on the confidence level corresponding to each of the plurality of recognition targets. This allows a more appropriate class to be determined.

### Third Embodiment

A third embodiment is described in which some of the configurations of the first embodiment are changed. The same configuration as in the first embodiment will be omitted with the same symbol.

Class combinations that are prone to error are known empirically. For example, class estimation between “motorcycle” and “pedestrian” is prone to error. Similarly, depending on the imaging angle and distance, class estimation is likely to be wrong between “bus”, “truck”, and “passenger car”. Similarly, class estimation is likely to be wrong between “stroller” and “pedestrian”, between “motorcycle” and “stroller”, between “motorcycle” and “pedestrian”, and between “stroller” and “children's vehicle”, respectively.

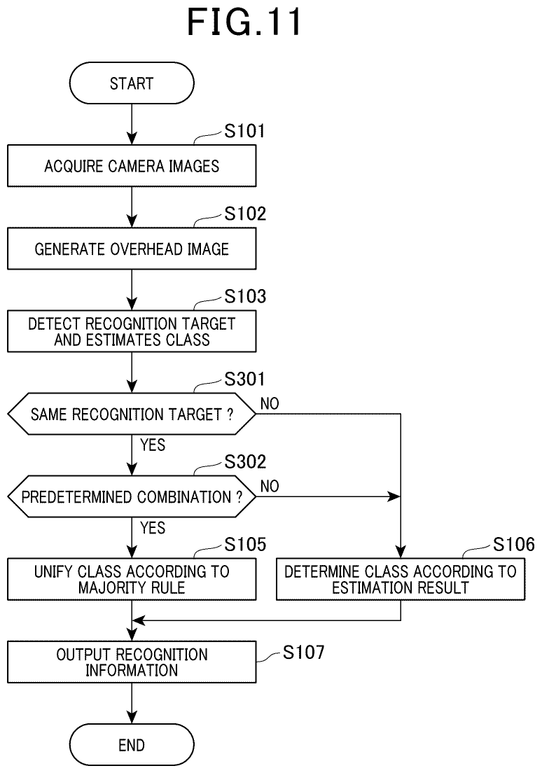

The image recognition device 30 of the third embodiment determines whether they are the same recognition target and performs the class estimation based on a combination of classes that can easily be mistakenly estimated. The flow of the image recognition process in the third embodiment is described below with reference to FIG. 11. In the image recognition process in the third embodiment, the process from step S101 to S103 is the same as in the first embodiment.

Similar to step S104 of the first embodiment, the determination unit 34 of the image recognition device 30 determines whether the plurality of recognition targets of whose classes are estimated to be different by the estimation unit 33 are located within the first region (step S301). As in the first embodiment, the determination unit 34 determines the plurality of recognition targets located within the first region to be a group of the recognition targets that are the same recognition targets, and when there are a plurality of such groups, each group is identified.

When the result of this determination is affirmative, the determination unit 34 determines whether the combination of classes estimated for the plurality of recognition targets located within the first region is one of the predetermined combinations (step S302). When there are plurality of groups of recognition targets that are determined to be the same recognition target, the determination unit 34 determines for each group whether the combination of classes of the recognition targets belonging to the group is the predetermined combination.

Each of the predetermined combinations is a combination of classes that are likely to be determined incorrectly, as described above. For example, they may be combination of “motorcycle” and “pedestrian”, combination of “bus”, “truck” and “passenger car”, combination of “stroller” and “pedestrian”, combination of “motorcycle” and “stroller”, combination of “stroller” and “children's vehicle”, and the like. There may be other combinations than these, and the type and number of classes in a combination may be changed arbitrarily.

When the result of this determination is affirmative, the class determination unit 35 of the image recognition device 30 unifies the class of the plurality of recognition targets with different classes according to majority rule, similar to step S105 of the first embodiment. As shown in FIG. 4, when there are a plurality of groups of the recognition targets that are considered to be the same recognition target, the class determination unit 35 unifies the class of the recognition target included in the group in a unified manner for each group.

On the other hand, when the determination result of step S301 or step S302 is negative, the class determination unit 35 determines the class estimated by the estimation unit 33 as the class of each of the recognition target (step S106).

The image recognition device 30 outputs the position of the detected recognition targets and the recognition information about the class of each of the recognition targets determined in step S105 or step S06 to the outside (step S107). Then the image recognition device 30 ends the image recognition process.

According to the above embodiment, the following effects can be achieved.

As mentioned above, it is empirically known that there are combinations of classes that are prone to error in the class estimation. Therefore, when a plurality of recognition targets that are estimated to have different classes exist within the first predetermined distance, and when the class combination of each recognition target that exists within the range is one of the predetermined class combinations, the determination unit 34 determines that they are the same recognition targets. This enables more accurate determination.

The third embodiment and the second embodiment may be combined. For example, in the image recognition process of the second embodiment, when the determination result of step S204 is affirmative, step S305 may be performed.

In the third embodiment, step S302 and step S301 may be interchanged to determine whether the distance between the plurality of recognition targets that make up the predetermined combination are located within the first region, when one of the predetermined combinations exists.

In the third embodiment, instead of determining the class according to majority rule, the class may be determined based on the confidence level, as in the second embodiment.

### Variant Examples

A variant in which some of the configurations in the above embodiment are changed is shown below.

In the above embodiments, the class determination unit 35 or the class determination unit 135 may use a second algorithm different from a first algorithm to determine the class of the plurality of recognition targets with different classes when the plurality of recognition targets with different classes are determined to be the same recognition targets. The first algorithm is the algorithm used by the estimation unit 33 or the estimation unit 133 to detect the recognition target and estimate its class. For example, when the estimation unit 33 or the estimation unit 133 use a convolutional neural network (CNN), the class determination unit 35 or the class determination unit 135 may use semantic segmentation to determine the class. The class determination unit 35 or the class determination unit 135 may also determine the class by combining a plurality of methods. For example, the class determination unit 35 or the class determination unit 135 may determine the class by weighting based on the confidence level, calculating the total confidence level for each class of recognition target determined to be the same recognition targets, and comparing the total values. For example, the confidence level of each class calculated using a convolutional neural network may be compared with the confidence level of each class calculated using semantic segmentation, and the class with the highest confidence level may be determined as the class to be recognized.

The first embodiment and the second embodiment may be combined. For example, the estimation unit 33 in the first embodiment may, like the estimation unit 133 in the second embodiment, calculate the confidence level of each recognition target class detected from a plurality of camera images acquired by the monocular camera 20 in a time series. Then, the class determination unit 35 of the first embodiment may unify the classes of the recognition targets based on the confidence level, similar to the class determination part 135 in the second embodiment. For example, the class determination unit 35 of the first embodiment may calculate the average value of the confidence level for each estimated class and uniquely determine the class with the highest average value as the class of the plurality of recognition targets.

Specifically, in the camera image at time t1, the recognition target TA1, whose class is “pedestrian” and whose confidence level is 60%, is detected; in the camera image at time t2, the recognition target TA2, whose class is “motorcycle” and whose confidence level is 70%, is detected; in the camera image at time t3 In the camera image at time t3, the recognition target TA3, whose class is “pedestrian” and the confidence level is 70%, is detected, in the camera image at time t4, the recognition target TA4, whose the class is “motorcycle” and the confidence level is 80%, is detected, and in the camera image at time t5, the recognition target TA5, whose class is “motorcycle” and whose confidence level is 90%, is detected. In this case, the average confidence level in the class “pedestrian” is 65% and the average confidence level in the class “motorcycle” is 80%. Therefore, class 35 determines “motorcycles” as the correct class. The class with the highest confidence level (in the above example, “Motorcycle” with a confidence level of 90%) may be determined as the correct class.

The class determination unit 135 of the second embodiment may also determine the class based on detection information from plurality of camera images acquired by each camera in time series. A specific example is shown and explained below. In the camera image of the front camera 121 at time t1, the recognition target TA1 whose class is “pedestrian” is detected, in the camera 1a image of the front camera 121 at time t2, the recognition target TA2 whose class is “motorcycle” is detected, and in the camera image of the front camera 121 at time t3, the recognition target TA3 whose the class is “pedestrian” is detected, in the camera image of the left-side camera 123 at time t1, the recognition target TB1 whose class is “motorcycle” is detected, and in the camera image of the left-side camera 123 at time t2, the recognition target TB2 whose class is “motorcycle is detected, and in the camera image of the left-side camera 123 at time t3, the recognition target TB3 whose class is “motorcycle”, is detected. In this case, the class determination unit 135 of the second embodiment may determine the class according to majority rule as in the first embodiment. In the above example, “motorcycle” may be determined as the class. As in the second embodiment, the class may be determined based on the confidence level. For example, the class may be determined based on the average confidence level for each class, or the class may be determined based on the highest confidence level.

The first embodiment may further include the class determination unit 135 in the second embodiment. That is, a class confidence level may be set, and when the plurality of the recognition targets are determined to be the same, the class determination unit 135 may determine unify class based on the confidence level.

The determination unit 34 or the determination unit 134 of the above embodiments may determine that a plurality of the recognition targets of different classes exists within the range of the first predetermined distance when another recognition target is included within the range of the first predetermined distance centered on the one recognition target and another recognition target is included within the range of the first predetermined distance centered on the other recognition target. The determination may be made that recognition targets of different classes exist within the range of the first predetermined distance.

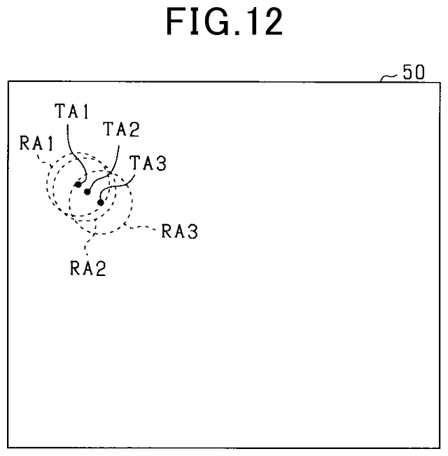

For example, as shown in FIG. 12, the positions of the recognition targets TA1 to TA3 of different classes are detected in the overhead image. In this case, when the first predetermined distance range RA1 centered on the recognition target TA1 includes the recognition targets TA2 and TA3, and the first predetermined distance range RA2 centered on the recognition target TA2 includes the recognition targets TA1 and TA3, and the first predetermined distance range RA3 includes the recognition target TA1 and the recognition target TA2, the determination unit 34 may determine that the recognition targets TA1 to TA3 of different classes exist within the range of the first predetermined distance.

The determination unit 34 of the first embodiment may sets the range of the first predetermined distance centered on each recognition target detected at the second (last) time, but it may also set the range of the first predetermined distance centered on any of the recognition targets detected from the first time to just before the second time.

In the above embodiment, the image recognition device 30 outputs the processing results to the monitor 40, but it may also output the processing results to external devices other than the monitor 40. For example, it may output the processing results to a vehicle control device that implements automatic operation of the vehicle or provides driving support.

The control unit and methods described in this disclosure may be realized by a dedicated computer provided by comprising a processor and memory programmed to perform one or more functions embodied by a computer program. Alternatively, the control unit and methods described in this disclosure may be realized by a dedicated computer provided by configuring a processor with one or more dedicated hardware logic circuits. Alternatively, the control unit and its methods described in this disclosure may be realized by one or more dedicated computers provided by a combination of a processor and memory programmed to perform one or more functions and a processor configured by one or more hardware logic circuits. The computer program may also be stored in a computer-readable non-transitory recording medium as instructions to be executed by a computer.

The following is a description of the technical ideas that can be derived from the above embodiments and variations.

### [Configuration 1]

An image recognition device (30, 130) including:
an acquisition unit (31, 131) that acquires camera images captured by at least one camera;
an estimation unit (33, 133) that detects recognition targets in the camera images and estimates a class of the detected recognition targets respectively; and
a determination unit (34, 134) that determines whether a plurality of recognition targets that are estimated to be of different classes are the same recognition targets.

### [Configuration 2]

The image recognition device according to Configuration 1, wherein
when the plurality of recognition targets detected by the estimation unit in each of the plurality of camera images captured within a predetermined time and estimated to be of different classes are located within a first predetermined region, the determination unit determines that the plurality of recognition targets are the same recognition targets, and the first predetermined region is a region in which a distance from a reference point is less than or equal to a first predetermined distance.

### [Configuration 3]

The image recognition device according to Configurations 1 or 2, wherein
the determination unit, when the estimation unit detects a plurality of recognition targets of different classes in a plurality of camera images captured by one camera between a first time and a second time, and the plurality of recognition targets are located within a first region, determines that the plurality of recognition targets located within the first region and of different classes are the same recognition targets, and
the first predetermined region is a region in which a distance from a reference point is less than or equal to a first predetermined distance.

### [Configuration 4]

The image recognition device according to any one of Configurations 1 to 3, wherein
the determination unit changes the first predetermined distance according to the class estimated by the estimation unit.

### [Configuration 5]

The image recognition device according to any one of Configurations 1 to 4, wherein
the determination unit, when the estimation unit detects a plurality of recognition targets of different classes in a plurality of camera images captured by a plurality of cameras with partially overlapping image capture ranges respectively at the same time, and when the plurality of recognition targets are located within a second region, determines the plurality of recognition targets are the same recognition targets, and
the second predetermined region is a region in which a distance from a reference point is less than or equal to a second predetermined distance.

### [Configuration 6]

The image recognition device according to any one of Configurations 1 to 5, further including
a class determination unit (35), when the plurality of recognition targets of different classes is determined to be the same recognition targets by the determination unit, unifying each of the class of the plurality of recognition targets of different classes, based on the detection information in the plurality of camera images acquired in time series.

### [Configuration 7]

The image recognition device according to any one of Configurations 1 to 5, further including
a class determination unit (135), when the plurality of recognition targets of different classes is determined to be the same recognition targets by the determination unit, unifying each of the class of the plurality of recognition targets of different classes, based on detection information from a plurality of camera images captured by a plurality of cameras.

### [Configuration 8]

The image recognition device according to any one of Configurations 1 to 5, further including
a class determination unit (35), when the plurality of recognition targets of different classes is determined to be the same recognition targets by the determination unit, unifying each of the class of the plurality of recognition targets of different classes according to a majority rule.

### [Configuration 9]

The image recognition device according to any one of Configurations 1 to 5, wherein
the estimation unit sets the confidence level of class estimation for each recognition target, and
the image recognition device further includes a class determination unit (135), when the plurality of recognition targets of different classes are determined to be the same recognition targets by the determination unit, unifying each of the class of the plurality of recognition targets of different classes based on the confidence level.

### [Composition 10]

The image recognition device according to any one of Configurations 1 to 5, further including
a class determination unit, when the plurality of recognition targets of different classes is determined to be the same recognition targets by the determination unit, unifying each of the class of the plurality of recognition targets of different classes using an algorithm different from an algorithm used by the estimation unit to detect and estimate the class of the recognition target.

### [Configuration 11]

The image recognition device according to any one of Configurations 1 to 5, wherein
the determination unit, when the estimation unit detects the plurality of recognition targets of different classes, the plurality of recognition targets are located within a first predetermined region, and the combination of the classes of each of the plurality of recognition targets is a predetermined combination of the classes, determines the plurality of recognition targets are the same recognition targets, and
the first predetermined region is a region in which a distance from a reference point is less than or equal to a first predetermined distance.

### [Configuration 12]

A non-transitory computer-readable storage medium storing an image recognition program, the recognition program causing the computer to:
acquire camera images captured by at least one camera;
detect recognition targets in the camera images and estimates a class of the detected recognition targets respectively; and
determine whether a plurality of recognition targets that are estimated to be of different classes are the same recognition targets.

### [Configuration 13]

An image recognition method performed by an image recognition device, the image recognition method comprising:
acquiring camera images captured by at least one camera;
detecting recognition targets in the camera images and estimates a class of the detected recognition targets respectively; and
determining whether a plurality of recognition targets that are estimated to be of different classes are the same recognition targets.

### [Configuration 14]

An image recognition device (30, 130) including a memory storing instructions and a processor, the processor executes the instructions to:
acquire camera images captured by at least one camera;
detect recognition targets in the camera images and estimates a class of the detected recognition targets respectively; and
determine whether a plurality of recognition targets that are estimated to be of different classes are the same recognition targets.

What is claimed is:

1. An image recognition device comprising:
an acquisition unit that acquires camera images captured by at least one camera;
an estimation unit that detects recognition targets in the camera images and estimates a class of the respective detected recognition targets; and
a determination unit that determines whether a plurality of recognition targets that are estimated to be of different classes are the same recognition targets.

2. The image recognition device according to claim 1, wherein
when the plurality of recognition targets detected by the estimation unit in each of the plurality of camera images captured within a predetermined time and estimated to be of different classes are located within a first predetermined region, the determination unit determines that the plurality of recognition targets are the same recognition targets, and
the first predetermined region is a region in which a distance from a reference point is less than or equal to a first predetermined distance.

3. The image recognition device according to claim 1, wherein
the determination unit, when the estimation unit detects a plurality of recognition targets of different classes in a plurality of camera images captured by one camera between a first time and a second time, and the plurality of recognition targets are located within a first region, determines that the plurality of recognition targets located within the first region and of different classes are the same recognition targets, and
the first predetermined region is a region in which a distance from a reference point is less than or equal to a first predetermined distance.

4. The image recognition device according to claim 3, wherein
the determination unit changes the first predetermined distance according to the class estimated by the estimation unit.

5. The image recognition device according to claim 1, wherein
the determination unit, when the estimation unit detects a plurality of recognition targets of different classes in a plurality of camera images captured by a plurality of cameras with partially overlapping image capture ranges respectively at the same time, and when the plurality of recognition targets are located within a second region, determines the plurality of recognition targets are the same recognition targets, and
the second predetermined region is a region in which a distance from a reference point is less than or equal to a second predetermined distance.

6. The image recognition device according to claim 1, further comprising
a class determination unit, when the plurality of recognition targets of different classes is determined to be the same recognition targets by the determination unit, unifying each of the class of the plurality of recognition targets of different classes, based on the detection information in the plurality of camera images acquired in time series.

7. The image recognition device according to claim 1, further comprising
a class determination unit, when the plurality of recognition targets of different classes is determined to be the same recognition targets by the determination unit, unifying each of the class of the plurality of recognition targets of different classes, based on detection information from a plurality of camera images captured by a plurality of cameras.

8. The image recognition device according to claim 1, further comprising
a class determination unit, when the plurality of recognition targets of different classes is determined to be the same recognition targets by the determination unit, unifying each of the class of the plurality of recognition targets of different classes according to a majority rule.

9. The image recognition device according to claim 1, wherein
the estimation unit sets the confidence level of class estimation for each recognition target, and
the image recognition device further comprises a class determination unit, when the plurality of recognition targets of different classes are determined to be the same recognition targets by the determination unit, unifying each of the class of the plurality of recognition targets of different classes based on the confidence level.

10. The image recognition device according to claim 1, further comprising
a class determination unit, when the plurality of recognition targets of different classes is determined to be the same recognition targets by the determination unit, unifying each of the class of the plurality of recognition targets of different classes using an algorithm different from an algorithm used by the estimation unit to detect and estimate the class of the recognition target.

11. The image recognition device according to claim 1, wherein
the determination unit, when the estimation unit detects the plurality of recognition targets of different classes, the plurality of recognition targets are located within a first predetermined region, and the combination of the classes of each of the plurality of recognition targets is a predetermined combination of the classes, determines the plurality of recognition targets are the same recognition targets, and
the first predetermined region is a region in which a distance from a reference point is less than or equal to a first predetermined distance.

12. A non-transitory computer-readable storage medium storing an image recognition program, the recognition program causing the computer to:
acquire camera images captured by at least one camera;
detect recognition targets in the camera images and estimates a class of the detected recognition targets respectively; and
determine whether a plurality of recognition targets that are estimated to be of different classes are the same recognition targets.

13. An image recognition method performed by an image recognition device, the image recognition method comprising:
acquiring camera images captured by at least one camera;
detecting recognition targets in the camera images and estimates a class of the detected recognition targets respectively; and
determining whether a plurality of recognition targets that are estimated to be of different classes are the same recognition targets.
